(19) United States
(12) Patent Application Publication
(10) Pub. No.: US 2014/0013902 A1
(43) Pub. Date: Jan. 16, 2014

(54) DRIVE FORCE DISTRIBUTING APPARATUS

(71) Applicant: NISSAN MOTOR CO., LTD., Yokohama-shi (JP)

(72) Inventors: Katsuyoshi Ogawa, Yokohama-shi (JP); Atsuhiro Mori, Fujisawa-shi (JP); Shunichi Mitsuishi, Isehara-shi (JP); Eigo Sakagami, Kawasaki-shi (JP); Tetsu Takaishi, Chigasaki-shi (JP)

(21) Appl. No.: 13/936,329

(22) Filed: Jul. 8, 2013

(30) Foreign Application Priority Data
Jul. 10, 2012 (JP) 2012-154430
Jul. 12, 2012 (JP) 2012-156696
Aug. 13, 2012 (JP) 2012-179147

(51) Int. Cl. B60K 23/08

(52) U.S. Cl. CPC B60K 23/08
USPC 74/665 F

(57) ABSTRACT

A driving force distribution apparatus is provided that includes a first roller rotatable together with a main wheel transmission system associated with main drive wheels and a second roller rotatable together with a subordinate driving wheel transmission system associated with subordinate drive wheels. A driving force distribution is enabled to the subordinate drive wheels by adjusting the radial pressing force between the first roller and the second roller through a revolution of the second roller using a power of an inter-roller radial pressing force generating source to thereby control the driving force distribution between the main driving wheels and subordinate driving wheels. Further, an electromagnetic brake is provided that, when energized and supplied with current, generates a braking force to hold the revolution position of the second roller. When de-energized, no braking force will be produced so that the revolution of the second roller will be allowed.

### CROSS REFERENCE TO RELATED APPLICATIONS

This application claims priority to Japanese Patent Application Nos. 2012-154430 filed Jul. 10, 2012; 2012-156696 filed Jul. 12, 2012; and 2012-179147 filed Aug. 13, 2012, each of which is incorporated by reference herein in its entirety.

### TECHNICAL FIELD

The disclosure herein generally relates to a vehicle driving force distributing apparatus, and in particular relates to a vehicle driving force distribution apparatus of friction transmission type.

### BACKGROUND

A conventional drive force distributing apparatus has a first roller mechanically coupled to a transmission system of main drive wheels and a second roller mechanically coupled to a drive system of subordinate drive wheels. The apparatus operates the first roller and the second roller to make contact with each other at their outer circumferential surfaces to distribute a part of a torque being transmitted to the main drive wheels to the subordinate drive wheels. Accordingly, a torque transmission capacity between the rollers can be controlled by adjusting a radial pressing force between the first roller and the second roller. The torque transmission capacity therefore controls the distribution of the drive force between the main drive wheels and the subordinate drive wheels.

Such a mechanism for carrying out the drive force distributing control is proposed in Japanese Laid-Open Patent Application No. 2012-11794 A, by using an electric motor and the like as an inter-roller radial pressing force generation source and revolving or turning the rotation axis of the second roller about an eccentric axis, the second roller is displaced relative to the first roller so that the radial pressing force between first roller and second roller, i.e., a driving force distribution between the main drive wheels and subordinate drive wheels may be changed. In the driving force distribution apparatus described in Japanese Laid-Open Patent Application No. 2012-11794 A, as long as the driving force distribution to the subordinate wheel is necessary, the command value for the inter-roller pressing force remains a constant value. If, during this period, the constant and invariable value is maintained by continuously using the power from the inter-roller radial pressing force generation source, the problem of a large energy loss would occur.

To solve this problem, within a range in which no adverse effects would be posed on the inter-roller radial pressing force control (driving force distribution control between main and subordinate drive wheels), energy necessary for implementing the control is aimed to be suppressed.

More specifically, an irreversible transmission mechanism is provided that transmits the power from the inter-roller radial pressing force generation source irreversibly in accordance with the command value of the inter-roller pressing force, so that, as long as the inter roller radial pressing force command value remains unchanged, by making the inter-roller radial pressing force generation source inoperative so that the inter-roller pressing force will be maintained at the command value.

However, in the configuration described in Japanese Laid-Open Patent Application No. 2012-11794 A, at a system failure, due to the operation of the irreversible mechanism, a continuous inter-roller pressing force may generate. In this case, there is a problem that durability may deteriorate due to increase in driving load of the subordinate driving system. In other words, in the driving force distribution apparatus disclosed in Japanese Laid-Open Patent Application No. 2012-11794 A, a room for improvement in a fail-safe performance remains to be addressed. The present invention has been made in view of the problem described above, and aims to propose a driving force distribution apparatus to improve the fail-safe function.

In Japanese Laid-Open Application Publication No. 2009-173261, a conventional drive force distributing apparatus is provided with a first roller rotatable together with a main drive wheel transmission system, a second roller rotatable together with a subordinate drive wheel transmission system, a crankshaft for rotatably supporting the second roller about an eccentric axis that is offset from the rotation center of the second roller, and an electric motor (a radial pressing force control actuator) for rotatably driving the crankshaft. In the conventional technique, by driving to rotate the crankshaft by the electric motor to revolve the second roller about the eccentric axis to thereby displacing the second roller relative to the first roller so that the radial pressing force between both rollers, i.e. the driving force distribution between the main drive wheels and the subordinate drive wheels are changed.

However, in the conventional technique described above, after the crankshaft has reached a rotation angle at which the inter-roller radial pressing force meets the command value and the target distribution between the main and subordinate drive wheel driving force distribution is achieved, even in a situation where the command value of the inter-roller radial pressing force is unchanged, it is necessary to continue to supply power to hold the rotation angle. Thus, there is a problem that a large amount of power consumption is needed.

### BRIEF SUMMARY

In order to address these concerns, the driving force distribution apparatus according to the present invention is configured in the following manner. An assumed configuration of the driving force distribution apparatus is now explained. It is composed of a first roller rotatable together with a main wheel transmission system and a second roller rotatable together with a subordinate driving wheel transmission system, and by pressing these first and second rollers against each other, a driving force distribution to the subordinate drive wheels may be possible, and by using the power of an inter-roller radial pressing force generation source and revolving or turning either the first or second roller to adjust the inter-roller pressing force between these rollers to thereby control the driving force distribution between the main drive wheels and subordinate drive wheels. The present invention is characterized by provision of an electromagnetic brake described below, in addition to the driving force distribution apparatus thus described. That is, the electromagnetic is capable of generating a braking force in response to current supply or energize to hold the revolving or turning position of either the first or second roller, and, without the current being supplied, i.e., when de-energized, no braking force will be generated so as to allow the revolution of either the first or second roller.

Due to the driving force distribution apparatus according to the present invention, the following operational effects may be obtained. Specifically, while the inter-roller radial pressing force is held unchanged, by supplying a current to the electromagnetic brake to generate a braking force so as to maintain the position of revolution of either the first or the second roller, even upon the inter-roller radial pressing force generating force being made inoperative, the inter-roller radial pressing force may be maintained at the command value. In addition, when the electromagnetic brake is not supplied with a current, by allowing either the first or second roller to revolve without generating a braking force, such as situation may be avoided where the inter-roller radial pressing force will be generated continuously at a system failure. Thus, the problem associated with driving load of the subordinate drive wheels may be avoided and the fail-safe function may be improved.

Furthermore, in the conventional technique described above, if the electric motor fails during a four-wheel driving travel, the crankshaft rotation angle is fixed due to the irreversibility of the torque diode so that no transition to a two-wheel driving mode is ensured. In this case, since the subordinate drive wheel is subjected to driving force distribution on a continual basis, the problem arises such as overheating of oil temperature of a differential gear.

The present invention has been made with focusing on the problem described above and aims to achieve the transition to the two-wheel drive mode despite the failure of the radial pressing force control actuator during a four-wheel driving operation.

An electromagnetic brake is provided to impart a braking force in accordance with the current supply to the coil to the second roller eccentric supporting member that supports the second roller freely rotatable about the eccentric axis. Accordingly, when maintaining the radial pressing force between the two rollers, a braking force is produced by current supply to energize the coil of the electromagnetic brake so that the rotation of the second roller about the eccentric axis may be stopped while maintaining the radial pressing force control actuator inoperative.

In addition, since the braking force will be zero due to stopping of the current supply to the coil, the second roller eccentric axis supporting member will be returned to a position in which the driving force distribution to the subordinate drive wheel will be zero due to a radial pressing reaction force. Therefore, even if a failure occurs on the radial pressing force control actuator during four-wheel drive mode, transition or shift to two-wheel drive mode may be achieved.

Also according to the present invention, when the rotation angle of crankshaft has reached a target value, the electric motor is rendered inoperative while the electromagnetic brake is supplied with a current corresponding to the rotation angle of the crankshaft.

Therefore, by stopping output of the electric motor and holding the rotation angle of the crankshaft by a braking force of the electromagnetic brake, power consumption may be suppressed. In addition, with respect to the change in friction force of electromagnetic brake to hold the crankshaft rotation angle, by supplying a current in accordance with the rotation angle, the consumed power is kept to a minimum.

### BRIEF DESCRIPTION OF DRAWINGS

FIG. 1 is a schematic top plan view of a power train of a four-wheel drive vehicle equipped with a driving force distribution apparatus according to a first disclosed embodiment;

FIG. 2 is a vertical cross-sectional side view of the drive force distributing apparatus shown in FIG. 1;

FIG. 3 is a vertical cross-sectional front view of a crankshaft used in the drive force distributing apparatus shown in FIG. 2;

FIGS. 4A-C are a series of views illustrating operation diagrams of the drive force distributing apparatus shown in FIG. 2, with FIG. 4A illustrating an operation diagram in which the first roller and the second roller are separated from each other at crankshaft rotation angle at reference position of “0” degree, FIG. 4B illustrating an operation diagram in which the first roller and the second roller are in contact state at 90 degrees, and FIG. 4C illustrating the contact state between the first roller and the second roller at crankshaft angle being at 180 degrees;

FIG. 5 is a flowchart illustrating the flow of calculation control process of a current command value of the electromagnetic brake in the transfer controller in the first embodiment;

FIG. 6 is a calculation map of the current command value in accordance with the crankshaft rotation angle of the first embodiment;

FIG. 7 is a schematic diagram of the driving force distributing apparatus in a second embodiment; and

FIG. 8 is a calculation diagram of the driving force distributing apparatus in a third embodiment.

### DETAILED DESCRIPTION OF EMBODIMENTS

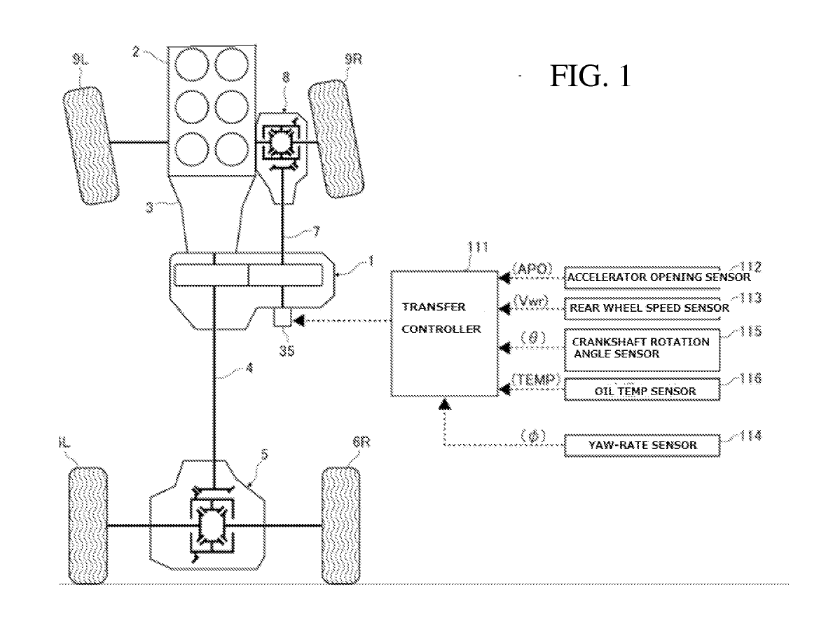

FIG. 1 is a schematic top plan view of a power train of a four-wheel drive vehicle equipped with a drive force distributing apparatus 1 according to a first embodiment. The four-wheel drive vehicle is based on a rear wheel drive configuration in which rotation from an engine 2 is multiplied by a transmission 3 and is transferred through a rear propeller shaft 4 and a rear final drive unit 5 in sequence to left and right rear wheels 6L and 6R. The vehicle can operate in a four-wheel drive manner by using the drive force distributing apparatus 1 to divert a portion of the torque being provided to the left and right rear wheels (main drive wheels) 6L and 6R through a front propeller shaft 7 and a front final drive unit 8 to transmit torque to left and right front wheels (subordinate drive wheels) 9L and 9R.

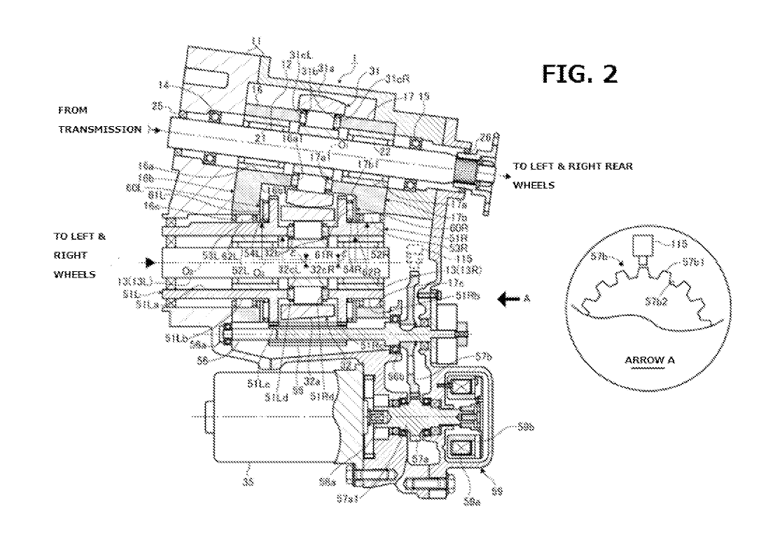

The drive force distributing apparatus 1 thus determines a drive force distribution ratio between the left and right rear wheels 6L and 6R and the left and right front wheels 9L and 9R. In this embodiment, the drive force distributing apparatus 1 can be configured as shown in FIG. 2. FIG. 2 is a vertical cross-sectional side view of the drive force distributing apparatus shown in FIG. 1. That is, as shown in FIG. 2, the apparatus includes a housing 11. An input shaft 12 and an output shaft 13 are arranged to span across an inside of the housing 11 diagonally with respect to each other such that a rotational axis O₁ of the input shaft 12 and a rotational axis O₂ of the output shaft 13 intersect each other. The input shaft 12 is rotatably supported in the housing 11 on needle bearings 14 and 15 located at both ends of the input shaft 12. Note that the ball bearing may be used in place of the needle bearing. Furthermore, both ends of the input shaft 12 protrude from the housing 11 and are sealed in a liquid-tight fashion or a substantially liquid-tight fashion by seal rings 25 and 26. In this arrangement, one end of the input shaft 12 shown at the left side of FIG. 2 is coupled to an output shaft of the transmission 3 (see FIG. 1). Also, the other end of the input shaft 2 at the right side of FIG. 2 is coupled to the rear final drive unit 5 through the rear propeller shaft 4 (see FIG. 1)

In addition, a pair of bearing supports 16 and 17 is provided between the input shaft 12 and the output shaft 13 in positions near the ends of the input shaft 12 and the output shaft 13. The bearing supports 16 and 17 are fastened to axially opposite internal walls of the housing 11 with fastening bolts (not shown), at approximate middle portions of the bearing supports 16 and 17. Note that the bearing support 16, 17 may not be fastened to housing 11. Bearing support 16, 17 is provided with an input shaft through bore 16a, 17a, output shaft through bore 16c, 17c for passing through the output shaft 13 and crankshaft 51L, 51R, and a vertical wall 16b, 17b connecting between the input shaft through bore 16a, 17a and output shaft through bore 16c, 17c, and is generally shaped glasses in the axial direction front view.

Roller bearings 21, 22 are arranged between the bearing supports 16, 17 and input shaft 12 for supporting the input shaft 12 freely or rotatably relative to bearing supports 16, 17 so that input shaft 12 is supported inside the housing 11 rotatably through the bearing supports 16, 17 as well. A first roller 31 is formed integrally and coaxially with the input shaft 12 in an axially intermediate position located between the bearing supports 16 and 17, that is, between the roller bearings 21 and 22. A second roller 32 is formed integrally and coaxially with the output shaft 13 in an axially intermediate position such that the second roller 32 can make frictional contact with the first roller 31. The first roller 31 and the second roller 32 are arranged in a drive force transmitting manner via working fluid or oil. Naturally, the first roller 31 can instead be attached to the input shaft 12 in any suitable manner instead of being integral with the input shaft 12.

Likewise, the second roller 32 can instead be attached to the output shaft 13 in any suitable manner instead of being integral with the input shaft 12. The outer circumferential surfaces of the first roller 31 and the second roller 32 are conically tapered in accordance with the diagonal relationship of the input shaft 12 and the output shaft 13 such that the outer circumferential surfaces can line contact each other. Note that, in place of the conically tapered surface, a crowing surface may be employed. For example, the first roller 31 may be formed in a protruding crowing shape while the second roller 32 may be formed with a recessed crowing shape. At both sides of radial extension of the first roller 31 and the second roller 32 are formed with retention grooves 31b, 32b to contact with and retain radially thrust bearings 31c1, 31cR, 32c1. 32cR. The thrust bearings 31cL, 31cR positions first roller 31 by contacting the first side walls 16a1, 17a1 of bearing supports 16, 17. On the other hand, the thrust bearings 32cL, 32cR positions second roller 32 by contacting the roller side contact portions 51Ld, 51Rd of crankshaft 51L, 51R described below.

The output shaft 13 is turnably or in a revolving way supported with respect to the bearings supports 16 and 17 at positions near both ends of the output shaft 13. Thus, the output shaft 13 is supported to be turned or revolved inside the housing 11 through the bearing supports 16 and 17. A support structure used to support the output shaft 13 in a revolving manner with respect to the bearing supports 16 and 17 is realized by an eccentric support structure as will now be explained.

A crankshaft 51L configured as a hollow outer shaft is moveably fitted between the output shaft 13L and the bearing support 16. Also, a crankshaft 51 R configured as a hollow outer shaft is moveably fitted between the output shaft 13R and the bearing support 17. The crankshaft 51L and the output shaft 13 protrude from the housing 11 as shown on the left side of FIG. 2. At the protruding portion, a seal ring 27 is installed between the housing 11 and the crankshaft 51L. Also, a seal ring 28 is installed between the crankshaft 51L and the output shaft 13. The seal rings 27 and 28 serve to seal the portions where the crankshaft 51 L and the output shaft 13 protrude from the housing 11 in a liquid-tight or substantially liquid-tight fashion.

The left end of the output shaft 13 protruding from the housing 11 in FIG. 2 is coupled to the front wheels 9L and 9R through the front propeller shaft 7 (see FIG. 1) and the front final drive unit 8.

A roller bearing 52L is arranged between a center hole 51La (radius Ri) of the crankshaft 51 L and a corresponding end portion of the output shaft 13. Also, a roller bearing 52R is arranged between a center hole 51 Ra (radius Ri) of the crankshaft 51 R and a corresponding end portion of the output shaft 13. Thus, the output shaft 13 is supported such that the output shaft 13 can rotate freely about the center axis O₂ inside the center holes 51 La and 51Ra of the crankshaft 51L and 51R

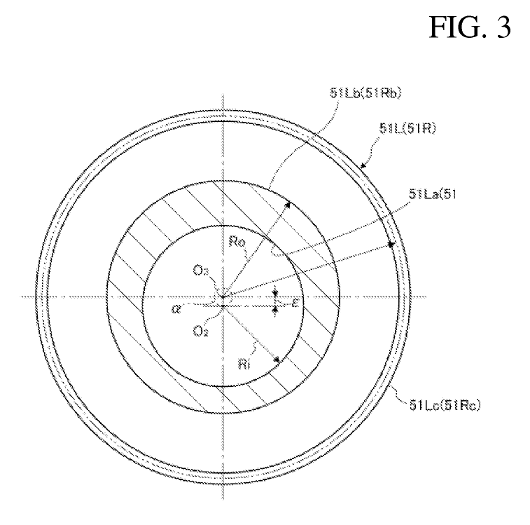

FIG. 3 is a vertical cross-sectional front view of a crankshaft used in the drive force distributing apparatus shown in FIG. 2. As shown clearly in FIG. 3, the crankshaft 51 L has an outer circumferential portion 51 Lb (center shaft axis O3, radius Ro) that is eccentric with respect to the center hole 51 La. Also, the crankshaft 51 R has an outer circumferential portion 51 Rb (center shaft axis O3, radius Ro) that is eccentric with respect to the center hole 51 Ra. The eccentric outer circumferential portions 51 Lb and 51 Rb are offset from the center axis (rotational axis) O₂ of the center holes 51 La and 51 Ra by an eccentric amount ε. The eccentric outer circumferential portion 51Lb of the crankshaft 51 L is rotatably supported inside the corresponding bearing support 16 through a roller bearing 53L. The eccentric outer circumferential portion 51Rb of the crankshaft 51 R is rotatably supported inside the corresponding bearing support 17 through a roller bearing 53R. In addition, the roller side contact portions 51Ld, 51Rd of crankshafts 51L, 51R are freely and rotatably supported on thrust bearings 32cL, 32cR. Further, thrust bearings 54L, 54R are provided axially outside with respect to thrust bearings 32cL, 32cR. These thrust bearings 54L, 54R contact spacers 60L, 60R rotatably and also contact ring gears 51Lc, 51Rc rotatably to thereby support crankshaft 51L and 51R rotatably free.

Spacers 60L, 60 R are composed of a first spacer portions 61L, 61R which respectively contacts the second wall surface 16b1, 17b1 of the vertical wall 16b, 17b facing the second roller 32 and respectively extends radially inwardly of output shaft through bore or hole 16c, 17c up to a position of contact free of the crankshaft 51L and a second spacer portions 62L, 62R (extension portion) that respectively extends to be inserted in the output shaft bore 16c, 17c. In addition, spacers 60L, 60R are positioned radially through contact between the outer periphery of the second spacer portions 62L, 62R and the inner periphery surface of output shaft through bores 16c, 17c while mutual interference between roller bearings 53L, 53R and thrust bearing 54R, 54L are avoided.

Crankshafts 51L, 51R are respectively formed integrally with ring gears 51Lc, 51Rc which face each other and provided at respective end of the associated crankshaft. These ring gears 51Lc, 51Rc are each meshed with a common crankshaft drive pinion 55 such that the crankshaft pinion is coupled to pinion shaft 56. The ring gears 51 Lc and 51Rc are meshed with the crankshaft drive pinion 55 such that the eccentric outer circumferential portions 51Lb and 51Rb of the crankshafts 51 L and 51R are aligned with each other in a circumferential direction. That is, the rotational positions of the eccentric outer circumferential portions 51 Lb and 51 Rb are in phase with each other.

The pinion shaft 56 is rotatably supported with respect to the housing 11 by bearings 56a and 56b arranged at both ends of the pinion shaft 56. At the right end of pinion shaft 56, in the ride side in FIG. 2, a large diameter output gear 57b is fixed. At the side of outer diameter of the large diameter output gear 57b is provided a crankshaft rotation angle sensor 115 which detects the protrusions and indents of teeth surfaces of the large diameter output gear 57b to detect the rotation angle of crankshaft 51L, 51R. The crankshaft rotation sensor 115 is a magnetic sensor to detect the protrusions and indents formed by the teeth of the large diameter output gear 57b and to detect the rotation angle of the pinion shaft 56 and that of crank shaft 51L, 51R. In the case of the rotation angle sensor of the type in which the teeth of the large diameter output gear 57b is detectable, as compared to the expensive arrangement such as a rotary encoder that requires components on both sides of the rotation body and the stator, rotation angle may be detected with much more compact space at low cost. In addition, consideration may be given advantageously to the arrangement in which the sensor can be mounted from the outer periphery side of housing 11 which provides a spacious area around periphery of the large diameter output gear 57b.

The large diameter output gear 57b is gear meshed with the small diameter output gear 57a. This small diameter output gear 57a is integrally formed with the small diameter output gear shaft 57a1. The small diameter output gear shaft 57a1 is attached to the output shaft of motor 35, i.e. motor drive shaft 35 at the left end side in FIG. 2 for jointly rotating the motor drive shaft 58a. Motor 35 is an electrically driven motor as an inter-roller radial pressing force generating source. At the right end side in FIG. 2of the small output gear shaft 57a1, an electromagnetic brake 59 is provided to fix the rotation of the small diameter output gear shaft 57a1. On the left and right of the small diameter output gear 57a is provided with a seal ring 63 and sealing 64 for sealing against inside of the electric motor 35 and electromagnetic brake 59.

An armature is provided on the clutch plate 59b. The clutch plate 59b moves axially due to electromagnetic attraction force to be fixed to yoke at the outer periphery of coil 59b in response to energizing of the coil 59a. When the electromagnetic clutch 59 is ON (engaged state), pinion shaft 56 may be fixed despite the application of torque on the side of pinion shaft 56 such that a predetermined inter-roller center distance may be maintained. On the other hand, when the electromagnetic clutch is in OFF state (released or disengaged state), the rotational movement of motor 35 may be transmitted to pinion shaft 56 to achieve a predetermined inter-roller center distance.

Note, rotational position control can be executed with respect to the crankshafts 51L and 51R by driving the crankshafts 51 L and 51 R with the inter-roller radial pressing force control motor 58 through the pinions 55 and the ring gears 51 Lc and 51Rc. When this occurs, the output shaft 13 and the rotation axis O₂ of the second roller 32 turn about the center axis (rotational axis) O₃ so as to revolve along a circular path a indicated with a broken line in FIG. 3.

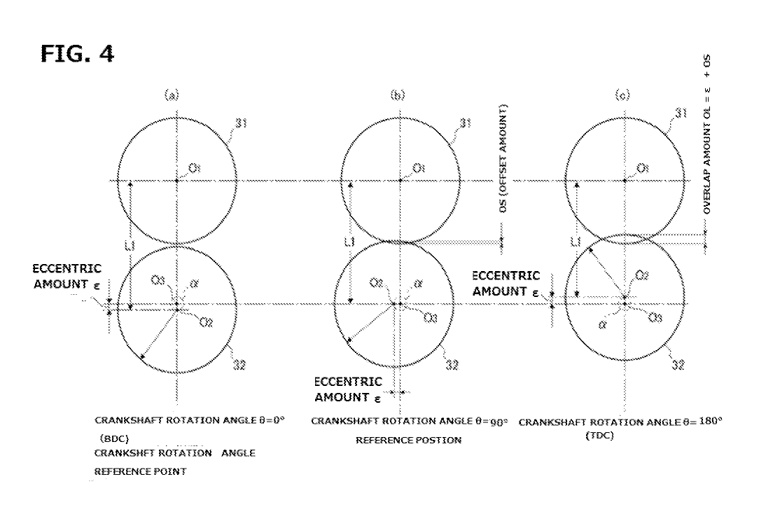

As will be described in detail later, by the turn or revolution of rotation shaft axis O2 (second roller 32) along a locus circle path a in FIG. 3, the second roller 32 approaches the first roller 31 as shown in FIGS. 4A to 4C in the radial direction. Thus, as the rotation angle θ of crankshafts 51L, 51R increases, the roller center distance L1 between the first roller 31 and the second roller 32 may be decreased less than the sum of the radius of the first roller 31 and the radius of the second roller 32 will cause the radial pressing force of the second roller 32 on the first roller 31 (inter-roller transmission torque capacity; traction transmission capacity) to be increased. Therefore, in response to the decrease in the inter-roller center distance L1, the inter-roller radial depressing force (inter-roller transmission torque capacity; traction transmission capacity) may be variably controlled to adjust the drive force distribution ratio freely.

Ring gear 51Lc, 51Rc, crankshaft drive pinion 55, a large diameter output gear 57b, and a small diameter output gear 57a make up a speed reduction gear disposed between motor 35 and crankshaft 51L, 51R. These speed reduction gears are reversible and are configured to rotate in a normal direction due to power of the motor 35 and to rotate in reversed direction by reaction force of inter-roller pressing force at the motor 35 being inoperative. More specifically, ring gear 51Lc, 51Rc, crankshaft drive pinion 55, a large diameter output gear 57b, and a small diameter output gear 57a are formed by reversible gears such as spur gears or helical gears.

FIG. 4 illustrates operation diagrams of the drive force distributing apparatus shown in FIG. 2. Motor 35 drives and rotates crankshaft 51L, 51R by its power through the speed reduction gear described above. Crankshaft 51L, 51R allow the second roller 32 to revolve by its rotation. More specifically, when crankshaft 51L, 51R rotates, the output shaft 13 and the rotation shaft axis O2 of the second roller 32 revolves about a center shaft line O3 along a circular path a indicated with a broken line in FIG. 3. A rotation angle reference point of crankshaft 51L, 51R (crankshaft rotation angle θ=0°) is defined, as shown in FIG. 4(a), at a bottom dead center in which the second roller rotation axis O2 is positioned directly beneath the crankshaft rotation axis O3 and the inter-axis distance between first roller 31 and second roller 12 assume the maximum. In the present embodiment, the traction control capacity may be controlled arbitrarily between zero (at θ=0°), and the maximum value obtainable at top dead center shown in FIG. 4(c),

More specifically, the inter-roller axis distance L1 in a state of bottom dead center (B.D.C.) is set larger than the sum of radius of first roller and the radius of second roller. Thus, at B.D.C where the crankshaft rotation angle θ is 0°, the first roller 31 and second roller 32 are not pressed radially (i.e. no traction transmission between rollers 31, 32 would take place where with the state of traction transmission capacity being 0). On the other hand, due to a revolution of rotation axis O2 (of second roller 32) along the locus circle α, second roller 32 approaches the first roller 31. The inter-roller axis distance L1 is configured to be smaller than the sum of the radius of the first roller 31 and that of the second roller 32 as rotation angle θ of crankshaft 51L, 51R increases. Due to decrease in this inter-roller distance L1, the radial pressing force (pressing pressure) of the second roller 32 relative to the first roller 31 will be large. Thus, depending on the degree of decrease, the inter-roller radial pressing force (inter-roller transmission torque capacity: traction transmission or transfer capacity), i.e. driving force distribution ratio may be controlled arbitrarily. In other words, since rollers 31 and 32 have an inter-roller transmission torque capacity in accordance with the radial, mutual pressing force, depending on this torque capacity, part of the torque for the left and right rear wheels (main drive wheels) is guided to output shaft 13 via first roller 31 and second roller 32 so that left and right front wheels (subordinate drive wheels) may be driven. Thus, the vehicle may travel in a four wheel drive by driving both the left and right rear wheels 6L, 6R as well as the left and right front wheels 9L, 9R.

Note that the traction transmission takes place by transmitting or transferring a tangential force (in the rotation direction) due to a shear stress of a working fluid which is enclosed in an elastically deformable contact point which is produced by pressing a pair of smooth rolling bodies, i.e. the first roller 31 and the second roller 32, relatively and radially. Therefore, it is preferable to use the working fluid with a high-limit shear (such as naphthenic base oil).

Note also that, during torque transmission, a reaction force of the radial pressing force between first roller 31 and second roller 32 are received by bearing supports 16, 17 without reaching housing or case 11. Further, the reaction force of the radial pressing force remains “0” when the crankshaft rotation angle is within a range between 0 and 90 degrees, increases in accordance with increase in crankshaft rotation angle θ between 90 and 180 degrees, and will assume the maximum value at the crankshaft rotation angle θ being 180 degrees.

During travel in the four-wheel drive mode, when the rotation angle θ of crankshaft 51L, 51R is set at a reference position of 90 degrees, the first roller 31 and second roller 32 are pressed against each other for frictional contact at a radial pressing force corresponding to an offset amount OS at this time, torque transmission takes place to left and right front wheels (subordinate drive wheels) 9L, 9R in accordance with the offset value OS between the two rollers. As the rotation angle θ of crankshaft 51L, 51R increases from the reference position shown in FIG. 4 (b) toward the top dead center with crankshaft rotation angle θ being at 180 degrees as shown in FIG. 4 (c), the inter-roller center distance L1 further decreases to increase the overlap amount OL between first roller 31 and second roller 32. Consequently, the radial pressing force between first roller 31 and second roller 32 will be increased to thereby increase the traction transmission capacity between these rollers. When crankshafts 51L, 51R have reached the position of top dead center shown in FIG. 4 (c), first roller 31 and second roller 32 are pressed at the maximum radial pressing force corresponding to the maximum overlap amount OL so that the traction transmission capacity between the two will be made maximum. Note that the maximum overlap amount OL is obtained by adding the eccentric amount E between the second roller rotation axis O2 and crankshaft rotation axis O3 to the offset amount OS described with reference to FIG. 4(b).

As will be appreciated from the description above, by operating crankshafts 51L, 51R to rotate from the position of “0” crankshaft rotation angle to the position of “180” crankshaft rotation angle, an inter-roller traction transmission capacity may be varied continuously from “0” to maximum. Conversely, by operating crankshafts 51L, 51R to rotate from the position of “180” crankshaft rotation angle to the position of “0” crankshaft rotation angle, the inter-roller traction transmission capacity may be varied continuously from maximum to “0”. Thus, the inter-roller traction transmission capacity may be controlled freely or variably by the rotational operation of crankshafts 51L, 51R.

Through the rotation of motor bi-directionally, crankshaft 51L, 51R rotates reversibly so that the direction of revolution of second roller 32 switches. By controlling to drive motor 35, the rotation position of crankshaft 51L, 51R (revolution position of second roller 32) is controlled. In other words, motor 35 represents an inter-roller pressing force control motor. Further, crankshaft 51L, 51R, pinion shaft 56, a large diameter output gear 57b, small-diameter output gear 57a, small diameter output gear shaft 57a1, and motor 35 constitutes an adjustment mechanism to adjust the radial pressing force of the second roller 32 against the first roller 31. During generation of the inter-roller pressing force (traction transmission capacity), a reaction force of the radial pressing force will be exerted on the second roller 32 and the adjustment mechanism. This reaction force of the radial pressing force remains “0” when the crankshaft rotation angle is within a range between 0 and 90 degrees, increases in accordance with increase in crankshaft rotation angle θ between 90 and 180 degrees, and will assume the maximum value at the crankshaft rotation angle θ being 180 degrees. Note that, during torque transmission, a reaction force of the radial pressing force between first roller 31 and second roller 32 are received by bearing supports 16, 17 without reaching housing or case 11.

The electromagnetic brake 59 operates using the electromagnetic force generated in response to energize or current supply to coil 59a (switching between an engaged and released states). Through engagement, braking or holding to stop a rotating member (small diameter output gear shaft 57a1) is possible, and the electromagnetic brake 59 is configured of a so-called normally open type which is placed in a released state at the current supply being stopped. The electromagnetic 59 has a coil 59a for generating a electromagnetic force, a housing 11 accommodating a yoke 59b jointly with coil 59a, a plate 59c fixed (through a bolt fastening) to the right end of the small diameter output gear shaft 57a1, and an armature 59d fixed on one side surface of plate 59c (outer periphery) so as to face an axial end surface of yoke 59b with a predetermined axial gap CL (air gap) interposed. Plate 59c is (at free end of outer periphery not fixed to the small diameter output gear shaft 57a1) an elastic member that is capable of being bent axially or compressed.

By supplying a current to coil 59a, a magnetic circuit is formed between yoke 59b and armature 59d, a magnetic attraction is generated to attract the armature 59d toward yoke 59b. When the armature 59d is attracted to the side of yoke 59b, plate 59b (outer-periphery thereof) is bent to move the armature 59d axially and contact the axial end surface of yoke 59b, the electromagnetic brake 59 is turned ON (engaged state). In this state, due to a friction contact between armature 59d and yoke 59b, the small diameter output gear shaft 59a1 is suppressed from rotation. The magnitude of the friction contact (brake torque) is proportional to the magnetic attraction (current supply). On the other hand, when coil 59a is not excited and no magnetic force is generated, the gap CL described above is maintained with the electromagnetic brake 59 being OFF (released state). In this state, no restriction is posed on the rotation of the small diameter output gear shaft 57a1.

When the electromagnetic brake 59 is being ON (engaged state), even if a reaction torque is exerted on the side of pinion shaft 56, pinion shaft 56 may be fixed to maintain the predetermined inter-roller axis distance. Stated another way, electromagnetic brake 59 represents a holding mechanism of rotation angle of crankshaft 51L, 51R. On the other hand, when the electromagnetic brake 59 is OFF (released state), during the power generation of motor 35, since the rotation operation of motor 35 may be transmitted to pinion shaft 56, a predetermined axial distance L1 may be achieved. Also, during a non-operation state in which motor 35 does not produce power, due to both the reaction force of the inter-roller radial pressing force and the reversibility of the adjustment mechanism (speed reduction gear), crankshaft 51L, 51R is configured to rotate in a direction of the inter-roller axis distance L1 being larger so that the inter-roller, radial pressing force will be automatically zero.

During a four-wheel drive travel described above, transfer 1 outputs and conveys a part of the torque t left and right rear wheels (main drive wheels) 6L, 6R to left and right front wheels (subordinate drive wheels) 9L, 9R. Thus, the traction transmission capacity between the first roller 31 and the second roller 32 is required to correspond to a target front wheel drive force to be distributed to left and right front wheels (subordinate wheels) that is obtainable based on the drive force to left and right rear wheels (main drive wheels) 6L, 6R and the distribution ratio of front to rear wheel target drive force. In the present embodiment, in order to perform a required traction transmission capacity control, a transfer controller 111 is provided shown in FIG. 1 to carry out control of the rotational position (control of rotation angel θ of crankshaft) of motor 35.

Therefore, transfer controller 111 receives a signal from accelerator pedal opening sensor 112 to detect the accelerator depressing amount (accelerator pedal opening degree) APO to adjust the output of engine 2, a signal from rear wheel speed sensor 113 to detect the rotational peripheral speed Vwr of left and right rear wheels 6L, 6R (main drive wheels), a signal of yaw-rate sensor 114 to detect a yaw-rate φ about the vertical axis passing through the center of gravity of the vehicle, a signal from the crankshaft rotation angle sensor 115 to detect the rotation angle θ of crankshaft 51L, 51R, and a signal of a oil temperature sensor 116 to detect a temperature TEMP of working oil within the transfer 1 (housing 11).

Based on the detection information of each sensor 112 to 116 described above, transfer controller 111 generally controls the traction transmission capacity (front to rear wheel drive force distribution control of four wheel drive vehicle) in the following manner.

Specifically, transfer controller 111 first obtains both the drive force of the left and right wheels 6L, 6R (main drive wheels) and the front to rear target drive force distribution ratio in a known manner based on an accelerator opening AP, rear wheel speed Vwr, and a yaw rate 6. Subsequently, transfer controller 111 acquires a target front wheel drive force to be conveyed to left and right front wheels (subordinate wheels) 9L, 9R based on the drive force of left and right rear wheels 6L,6R (main drive wheels) and the target distribution ratio between front and rear drive force.

Subsequently, transfer controller 111 acquires, by referring to a map and the like, an inter-roller radial pressing force (traction capacity between the first roller 31 and the second roller 32) required to transmit the target front driving force by the first and second rollers 31, 32. Transfer controller 111 further calculates a command value for a target rotation angle tθ of crankshaft 51L, 51R necessary to achieve the inter-roller radial pressing force (traction transmission capacity) (see FIGS. 2, 3) to calculate a target revolution position of the rotation axis of second roller (O2), target front wheel drive force to be conveyed to left and right front wheels (subordinate wheels) 9L, 9R based on the drive force of left and right rear wheels 6L,6R (main drive wheels) and the target distribution ratio between front and rear drive force.

Further, transfer controller 111 obtains a required radial inter-roller pressing force (traction transmission capacity) imparted by first roller 31 and second roller 32 necessary to transmit the target front drive force, and then calculates a target rotation angle tθ of crankshaft 51L, 51R (see FIGS. 2, 3), that is, target rotation angle of second roller axis O2 necessary to achieve the radial inter-roller pressing force (traction transmission capacity between first roller 31 and second roller 32).

Moreover, transfer controller 111 also carries out an engagement control of the electromagnetic brake 59 in the following manner. Specifically, after the crankshaft rotation angle θ has matched the target crankshaft rotation angle tθ (i.e. matched the command value of the inter-roller radial pressing force), as long as the command value for inter-roller radial pressing force is maintained constant, a predetermined current is supplied to coil 59a to engage electromagnetic brake 59 and then to terminate the driving control of motor (current supply to motor 35). Then, in response to change in command value of the inter-roller pressing force, driving control of motor 35 (current supply to motor 35) is resumed to end the current supply to coil 59a to release electromagnetic brake 59. Thus, by making motor 35 inoperative after having motor 35 operative, or by releasing electromagnetic motor 59 after making motor 35 operative, the of torque release of crankshaft 51L, 51R will be avoided and fluctuations in the revolution position of the second roller 32 may be suppressed.

The driving force distribution apparatus described above is now described. As long as the driving force distribution to the subordinate drive wheels is required, in response to a constant command value of the inter-roller radial pressing force, while the inter-roller radial pressing force is held at a constant command value by using power of the inter-roller radial pressing force generating source, energy loss is high. To solve this problem, an irreversible transmission mechanism is provided, which transmits the power from the inter-roller radial pressing force generating source irreversibly. It is conventionally known to hold the inter-roller radial pressing force at the command value by the irreversible transmission mechanism during a period in which the inter-roller radial pressing force command is unchanged. However, in the configuration of the conventional technique, at system failure, there is a risk in which the inter-roller radial pressing force will be generated continuously by the operation of the irreversible transmission mechanism so that the subordinate drive system is subjected to an increased load and the durability thereof may be decreased.

By contrast, in the driving force distribution apparatus in the present first embodiment, while the inter-roller radial pressing force is unchanged, a braking force is generated by supplying current to electromagnetic brake 59 (engaged state), and by holing the revolution position of second roller 32 (of the rotation shaft O2 of second roller), even if motor 35 is made inoperative, the inter-roller radial pressing force may be held at the command value. Thus, as in the case of conventional technique, even during a period of the driving force distribution control, the period of motor 35 being held inoperative, i.e., the period to hold the energy consumed for the driving force distribution zero, is obtained. Therefore, as compared to the case in which the inter-roller radial pressing force is held at the command value by using a power of motor 35 continuously, the energy consumed (power consumption) may be suppressed. Note that, based upon the investigation conducted by the present Applicant, when the electromagnetic brake 59 is used to hold the inter-roller radial pressing force, the current required is verified as small as about one sixtieth compared to the holding operation using the power of motor 35.

Note that, during a straight travel, in an operating condition in which a high precision driving force distribution control is not required such as ABS (wheel braking lock prevention control) or VDC (vehicle behavior stabilizing control), it is possible to control motor 35 using a low-resolution, inter-roller radial pressing force command value (low resolution map). In this case, the period in which the inter-roller radial pressing force command value is held constant, i.e., the period where motor 35 is kept inoperative or deactivated (while engaging the electromagnetic brake 59) will be extended so that the energy suppression effect may be improved.

In addition, during a four-wheel drive, at a system failure (at failure of control system such as transfer controller 111 or at failure of power source), the electromagnetic brake 59 is brought to a non-energized state so as not to generate braking force. In other words, even in a state in which, as described above, engagement of the electromagnetic brake 59 is being commanded to suppress the consumption energy, upon system failure, electromagnetic brake 59 is turned OFF (released state) by cutting off the current supply. Also, motor 35 is held inoperative at this time. Therefore, the second roller 32 is allowed to revolve, and, in response to a reaction force of the inter-roller radial pressing force, crankshaft 51L, 51R rotates in a direction in which the inter-roller axis distance will be larger and the inter-roller radial pressing force will be automatically assume zero to transfer to a two-wheel drive mode with rendering the driving force imparted to the left and right front wheels (subordinate wheels) 9L, 9R to zero. Thus, the problem associated with increase in driving load on the subordinate wheels described above may be avoided. In other words, the situation in which the inter-roller radial pressing force will be generated continuously at a system failure and the fail-safe performance will be improved compared to the conventional technology.

As described above, in the present embodiment, the effects listed below may be obtained.

A driving force distribution apparatus 1 includes a first roller 31 rotatable together with a main wheel transmission system associated with main drive wheels (left and right rear wheels 6L, 6R) and a second roller 32 rotatable together with a subordinate driving wheel transmission system associated with subordinate drive wheels (left and right front wheels 9L, 9R), and by pressing these first roller 31 and second roller 32 each other in a radial direction of both rollers to thereby enable a driving force distribution to the subordinate drive wheels while by adjusting the radial pressing force between the first roller 31 and the second roller 32 through a revolution of the second roller 32 using a power of an inter-roller radial pressing force generating source (motor 35) to thereby control the driving force distribution between the main driving wheels (left and right rear wheels 6L, 6R) and subordinate driving wheels (left and right front wheels 9L, 9R). Further, an electromagnetic brake 59 is provided that, when energized and supplied with current, generates a braking force to hold the revolution position of the second roller 32. When de-energized, no braking force will be produced so that the revolution of the second roller 32 will be allowed.

Therefore, with the inter-roller radial pressing force generating source (motor 35) being inoperative, by holding the revolution position of the second roller by way of the braking force of the electromagnetic brake 59, the driving force distribution control through the inter-roller radial pressing force control may be carried out with a small energy consumption, and by allowing the revolution of the second roller 32 with the electromagnetic brake 59 rendered to refrain from generating a braking force when de-energized, such a situation is avoided in which the inter-roller radial pressing force will be continuously generated at a system failure so that a fail-safe function is reinforced.

The inter-roller radial pressing force generating source is an electric motor (motor 35). Thus, by holing the revolution position of the second roller 32 by the electromagnetic brake 59 while holing motor 35 inoperative, the driving force distribution control via the inter-roller radial pressing force control may be carried out with small power consumption.

Crankshaft 51L, 51R for revolving the second roller 32 through its rotation, and a speed reduction gear (ring gear 51Lc, 51Rc, crankshaft drive pinion 55, and large diameter output gear 57b and small diameter output gear 57a) disposed between electric motor (motor 35) and crankshaft 51L, 51R are provided. Crankshaft 51L, 51R as well as the speed reduction gear have reversibility.

Therefore, at a system failure where electromagnetic brake 59 does not produce a braking force, due to a reaction force of the inter-roller pressing force and the reversibility of crankshaft 51L, 51R as well as the speed reduction gear, crankshaft 51L, 51R rotates in a direction in which the inter-roller axis distance L1 becomes larger so that the inter-roller pressing force will reduce to zero automatically. Thus, fail-safe capability is improved.

The embodiment for implementing the present invention has been described above with reference to the accompanying drawings. However, the specific structure is not limited to the embodiments, but the present invention includes design modifications which would not depart the gist of the invention.

For example, in the embodiment, as the driving force distribution apparatus, rollers 31, 32 are brought into a friction contact via working oil and torque is transmitted by the shear stress of this working oil. This does not restrictive. For example, rollers may be contacted directly to transmit the toque by friction between the rollers.

In the embodiment, the second roller 32 is revolved by the rotation of crankshaft 51L, 51R. However, a crankshaft for revolving the first roller 31 may be provided, and by revolving the first roller 31, the inter-roller radial pressing force may be adjusted.

In addition, the configuration of the electromagnetic is not limited to those in the embodiment. For example, instead of having the armature 59d and yoke 59b to contact due to an elastic deformation of plate 59c affixed to the small diameter gear shaft 57a1, a plate 59c may be provided to be axially displaceable (by spline fitting and the like) with respect to the small diameter gear shaft 57a1, and the plate 59c (armature 59d) may be biased in a spaced-away direction from yoke 59b by way of a biasing member such as a spring separately provided from this plate 59c. The prerequisite for the electromagnetic brake 59 is that the energy (power) required to hold the inter-roller radial pressing force at the command value is less than the inter-roller radial pressing force generating source (motor 35) and that it be of a normally open type. Further, the position of installation of the electromagnetic brake 59 is not limited to the first embodiment, but may be placed at an arbitrary position between motor 35 and crankshaft 51L, 51R. For example, electromagnetic motor 59 may be provided integrally with motor 35. Moreover, it is sufficient for the speed reduction gear disposed between motor 35 and crankshaft 51L, 51R that reversibility is ensured and rotatable despite the change between the driving side and driven side. The speed reduction gear may be formed by gears other than the spur gear or helical gear.

Transfer controller 111, upon the rotation angle θ of the crankshaft 51L, 51R matching the target value tθ, maintains the rotation angle θ by turning electromagnetic brake 590N while rendering the electric motor 35 inoperative. In this instance, the current value supplied to electromagnetic brake 59 is made the minimum current value required to maintain the rotation angle of crankshaft 51L, 51R.to thereby suppress the power consumption.

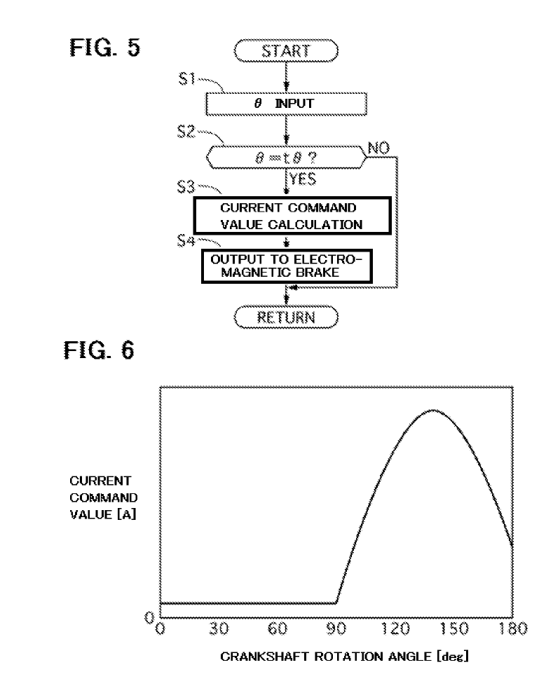

FIG. 5 is a flowchart illustrating the flow of calculation control process of a current command value of the electromagnetic brake in the transfer controller 111 in the first embodiment. Each step is not explained.

In Step S1, crankshaft rotation angle θ is received. In Step S2, determination is made as to whether crankshaft rotation angle θ matches the crankshaft rotation angle target value tθ, and if determined YES, control proceeds to Step S3 while, if NO, control returns. In Step S3, referring to the map shown in FIG. 6, a current command value in accordance with the crankshaft rotation angle θ is calculated. In Step S4, in order for the current supplied to electromagnetic brake 59 to reach the current command value calculated in step S3, the supply current will be adjusted to electromagnetic brake 59.

FIG. 6 is a calculation map of the current command value in accordance with the crankshaft rotation angle θ of the first embodiment. The current command value assumes the minimum (>0) while the crankshaft angle θ ranges between 0 degree and 90 degrees. With θ being in the range between 90 degrees and 135 degrees, the current command value increases as θ increases. In the range between 135 degrees and 180 degrees, the current command value decreases as the θ increases. The characteristics in current command value with respect to crankshaft rotation angle θ shown in FIG. 6 represents a minimum current value by which a braking torque of electromagnetic brake 59 may be produced in order to maintain the crankshaft rotation angle θ against the radial pressing reaction force between first roller 31 and second roller 32, i.e., to stop rotation of crankshaft 51L, 51R.

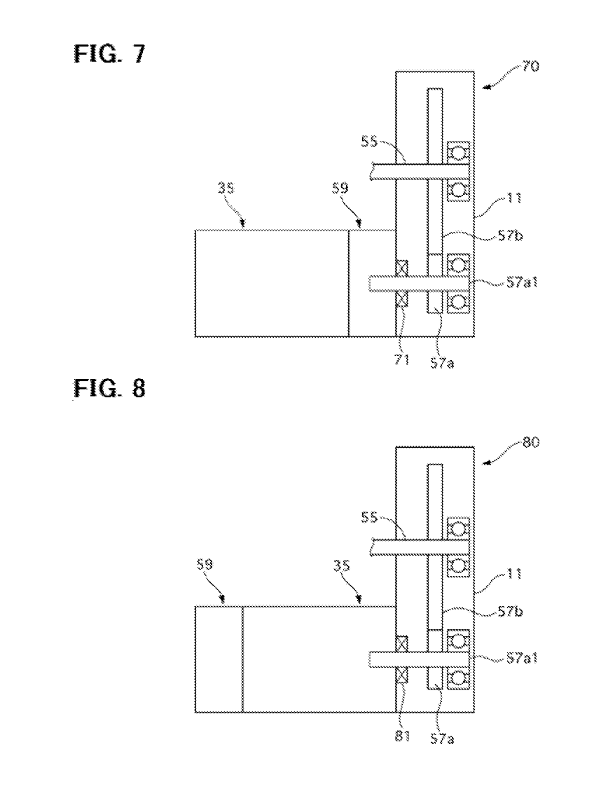

FIG. 7 shows a schematic diagram of a drive force distribution apparatus (transfer) in a second embodiment. In the second embodiment, the point of difference from the first embodiment resides in that electromagnetic brake 59 is disposed on the side of electric motor 59 with respect to small diameter output gear 57a and being interposed between small diameter output gear 57a and electric motor 35.

In FIG. 7, on the axially left side of the small diameter output gear shaft 57a is provided a seal ring 71 to seal the electromagnetic brake 59 against the inside of housing 11. Note that the other structures are the same as the first embodiment so that drawings and accompanied explanation are omitted.

According to the drive force distribution apparatus 70 in the second embodiment, the following operational effects are achieved. In the second embodiment, a small diameter output gear 57a is provided on the small diameter output gear shaft 57a1 assembled to motor drive shaft 58a of electric motor 35, and electromagnetic brake 59 is disposed on the side of electric motor 35 with respect to small diameter output gear 57a.

In contrast to the driving force distribution apparatus in the first embodiment where, due to a structure in which electric motor 35 and electromagnetic brake 59 are separately attached to housing 11, separate sealing structure is required to seal each location against the inside of the housing 11. In the drive force distribution apparatus 70 in the second embodiment 70, it is enough to provide a sealing structure for electromagnetic brake 59, and the sealing structure of electric motor 35 is not required. Thus, the sealing structure is simplified and the overall structure is simplified. Also, in contrast of the drive force distribution apparatus 1 in the first embodiment where two seal rings 63, 64 (see FIG. 2) are required, the drive force distribution apparatus in the second embodiment, one seal ring 71 will suffice so that number of required parts may be reduced.

FIG. 8 is a schematic diagram showing a driving force distribution apparatus (transfer apparatus) 80 in a third embodiment. In the third embodiment, The difference from the first embodiment resides in that electromagnetic brake 59 is displaced on the side of electric motor 35 with respect to the small diameter output gear 57a and opposite of the small output diameter gear 57a with electric motor 35 interposed.

In FIG. 8, on the axially left side of the small diameter output gear 57a is provided a seal ring 81 sealing the electric motor 35 against the inside of the housing 11. Note that the other structures are the same as the first embodiment, so that the drawings and explanation therefore are omitted here.

According to the third embodiment, following operational effects are achieved. In the driving force distribution apparatus 80 in the third embodiment, electromagnetic brake 59 is disposed at the opposite side of the small diameter output gear 57a with electric motor 35 interposed. By adopting the structure described above, since the shaft length extending between the position of attachment of the motor drive axis 58a to small diameter output gear shaft 57a1 and the small diameter output gear 57a may be set to be equal to that in the first embodiment, the axial force capacity is improved, and the sealing structure may be simplified, and the reduction in number of parts may be achieved.

What is claimed is:

1. A driving force distributing apparatus comprising:
a first roller rotatable together with a main wheel transmission system;
a second roller rotatable together with a subordinate driving wheel transmission system, the first roller and the second roller each configured to be pressed by a radial pressing force in a radial direction of both rollers to thereby enable a driving force distribution to the subordinate drive wheels, wherein adjustment of the radial pressing force between the first roller and the second roller through a revolution of either the first roller or the second roller using a power of an inter-roller radial pressing force generating source thereby controls the driving force distribution between the main driving wheels and the subordinate driving wheels; and
an electromagnetic brake which, when energized, generates a braking force to hold a revolution position of either the first roller or the second roller, and, when de-energized, allows the revolution of either the first roller or the second roller.

2. The driving force distribution apparatus as claimed in claim 1, wherein the inter-roller radial pressing force generating source is an electric motor.

3. The driving force distribution apparatus as claimed in claim 2, further comprising:
a crankshaft that, when rotated, revolves either the first roller or the second roller; and
a speed reduction gear interposed between the electric motor and the crankshaft, wherein both the crankshaft and the speed reduction gear are reversible.

4. The drive force distributing apparatus of claim 1 further comprising:
an input shaft rotatable together with the main wheel transmission system on which the first roller is rotatably disposed;
an output shaft rotatable together with the subordinate driving wheel transmission system on which the second roller is disposed;
a second roller eccentric axis supporting member for rotatably supporting the second roller about an eccentric axis offset from a rotation center of the second roller; and
a radial pressing force control actuator for driving rotation of the second roller eccentric axis supporting member, wherein the electromagnetic brake is configured to impart to the second roller eccentric axis supporting member a braking force in accordance with a current supply to a coil thereof.

5. The drive force distribution apparatus of claim 1 further comprising:
an input shaft rotatable together with the main wheel transmission system on which the first roller is rotatably disposed;
an output shaft rotatable together with the subordinate driving wheel transmission system on which the second roller is disposed;
a crankshaft for rotatably supporting the second roller about an eccentric axis offset from a rotation axis of the second roller, wherein the electromagnetic brake imparts the braking force to rotation of the crankshaft;
an electric motor for driving the crankshaft, wherein the second roller is caused to rotate about the eccentric axis by driving the electric motor causing periphery surfaces of both the first roller and the second roller to mutually friction contact to carry out the driving force distribution to the subordinate driving wheel transmission system; and
an eccentric rotation angle holding means for rendering the electric motor inoperative when a rotation angle of the crankshaft has reached a target value and supplying a current to the electromagnetic brake corresponding to the rotation angle.
